(19) United States
(12) Patent Application Publication
(10) Pub. No.: US 2026/0220790 A1
(43) Pub. Date: Jul. 30, 2026

(54) INFORMATION PROCESSING SYSTEM

(71) Applicant: CANON KABUSHIKI KAISHA, Tokyo (JP)

(72) Inventors: KUNITOSHI AOKI, Tokyo (JP); KOKI HONDA, Kanagawa (JP)

(21) Appl. No.: 19/452,027

(22) Filed: Jan. 16, 2026

(30) Foreign Application Priority Data
Jan. 24, 2025 (JP) 2025-010856

(51) Int. Cl. G06T 7/20

(52) U.S. Cl. CPC G06T 7/20

(57) ABSTRACT

A system includes a weighting unit configured to acquire a first inner product of time-series pixel data including a plurality of pixel values in time series as elements and a first coefficient sequence including a plurality of weighting coefficients respectively corresponding to the plurality of pixel values as elements, and configured to acquire a second inner product of the time-series pixel data and a second coefficient sequence including a plurality of weighting coefficients respectively corresponding to the plurality of pixel values as elements, and a calculation unit configured to calculate a reliability regarding calculation accuracy of an optical flow from the plurality of pixel values based on the first inner product and the second inner product.

### BACKGROUND

### Field of the Technology

The aspect of the embodiments relates to an information processing system.

### Description of the Related Art

A time correlation image sensor is disclosed in “Shigeru Ando and Akira Kimachi: ‘Time-Domain Correlation Imaging and Its Applications’, The transactions of the Institute of Electrical Engineers of Japan. A publication of Sensors and Micromachines Society, Volume 129, No. 5, pp. 129-137, May 1, 2009”. Further, in “Time-Domain Correlation Imaging and Its Applications”, a structure of a pixel circuit capable of detecting a time correlation and a method of calculating an optical flow are disclosed.

In time correlation imaging, information about the optical motion of an object in an image is obtained. The magnitude of the optical motion of the object may affect the calculation accuracy of the optical flow.

### SUMMARY

According to one aspect of the embodiments, there is provided a system including a weighting unit configured to acquire a first inner product of time-series pixel data including a plurality of pixel values in time series as elements and a first coefficient sequence including a plurality of weighting coefficients respectively corresponding to the plurality of pixel values as elements, and configured to acquire a second inner product of the time-series pixel data and a second coefficient sequence including a plurality of weighting coefficients respectively corresponding to the plurality of pixel values as elements, and a calculation unit configured to calculate a reliability regarding calculation accuracy of an optical flow from the plurality of pixel values based on the first inner product and the second inner product.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating an overall configuration of an information processing system according to a first embodiment.

FIG. 2 is a functional block diagram of the information processing device according to the first embodiment.

FIG. 3 is a schematic diagram illustrating an operation of a weighting unit according to the first embodiment.

FIG. 4A, FIG. 4B, and FIG. 4C are graphs illustrating an inner product operation according to the first embodiment.

FIG. 5A and FIG. 5B are diagrams illustrating examples of a reliability map and an optical flow map according to the first embodiment, respectively.

FIG. 6A and FIG. 6B are diagrams illustrating examples of a reliability map and an optical flow map according to a second embodiment, respectively.

FIG. 7 is a schematic diagram illustrating an overall configuration of a photoelectric conversion device according to a fourth embodiment.

FIG. 8 is a schematic block diagram illustrating a configuration example of a sensor substrate according to the fourth embodiment.

FIG. 9 is a schematic block diagram illustrating a configuration example of a circuit substrate according to the fourth embodiment.

FIG. 10 is a schematic block diagram illustrating a configuration example of one pixel of a photoelectric conversion unit and a pixel signal processing unit according to the fourth embodiment.

FIG. 11A, FIG. 11B, and FIG. 11C are diagrams illustrating an operation of an avalanche photodiode according to the fourth embodiment.

FIG. 12 is a diagram illustrating a configuration of a pixel according to the fourth embodiment.

FIG. 13A and FIG. 13B are schematic diagrams illustrating a configuration of a photoelectric conversion device according to a fifth embodiment.

FIG. 14A, FIG. 14B, and FIG. 14C are diagrams illustrating a configuration of pixels according to the fifth embodiment.

FIG. 15A, FIG. 15B, and FIG. 15C are diagrams illustrating an arrangement of pixels according to the fifth embodiment.

FIG. 16 is a functional block diagram of an information processing device according to a sixth embodiment.

FIG. 17 is a block diagram illustrating a schematic configuration of equipment according to a seventh embodiment.

FIG. 18A and FIG. 18B are block diagrams illustrating a schematic configuration of equipment according to an eighth embodiment.

### DESCRIPTION OF THE EMBODIMENTS

Hereinafter, embodiments will be described with reference to the drawings.

The same or corresponding elements are denoted by the same reference numerals throughout the several drawings, and the description thereof may be omitted or simplified.

### First Embodiment

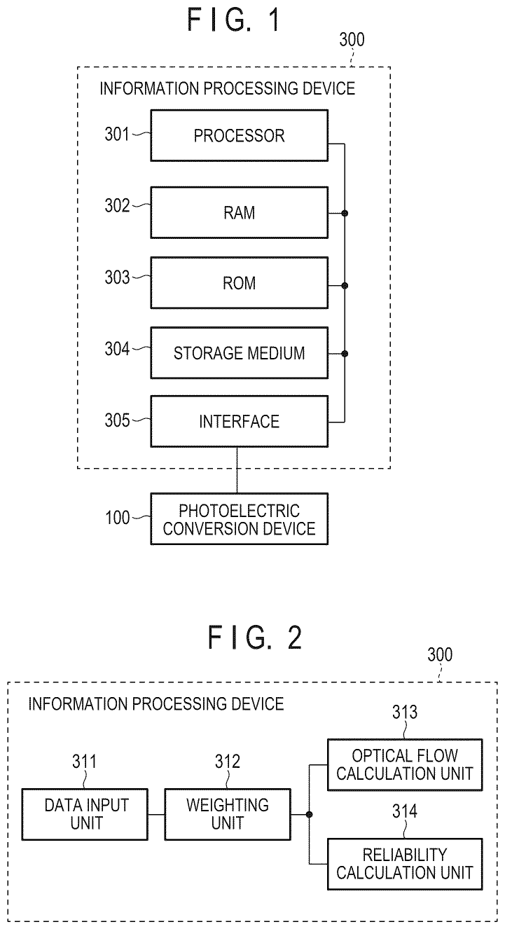

FIG. 1 is a block diagram illustrating an overall configuration of an information processing system according to the embodiment. The information processing system includes a photoelectric conversion device 100 and an information processing device 300. The photoelectric conversion device 100 includes a plurality of pixels arranged to form a plurality of rows and a plurality of columns. Each of the plurality of pixels generates a signal according to incident light by photoelectric conversion. The information processing device 300 acquires image data from the photoelectric conversion device 100 and processes the image data.

The information processing system may have a configuration other than that illustrated in FIG. 1. For example, the information processing system may be an integrated device including the functions of the photoelectric conversion device 100 and the information processing device 300. In addition, the information processing system may not include the photoelectric conversion device 100, and in this case, the information processing system acquires image data generated in advance in an external photoelectric conversion device from a memory or the like and processes the image data.

In the following description, it is assumed that the photoelectric conversion device is an imaging device that captures an image. However, the photoelectric conversion device to which the technology of each embodiment is applicable is not limited to an imaging device, and may be another device. For example, the technology of each embodiment can also be applied to a ranging device or a photometric device. Note that the ranging device is, for example, a focus detection device or a device that measures a distance using a time of flight (ToF). The photometric device is a device that measures the amount of incident light.

The information processing device 300 is, for example, a computer. The information processing device 300 performs arithmetic processing such as image processing on image data acquired from the photoelectric conversion device 100. The information processing device 300 may have a function of controlling the photoelectric conversion device 100.

The information processing device 300 includes a processor 301, a random access memory (RAM) 302, a read only memory (ROM) 303, a storage medium 304, and an interface 305. These units are connected to each other via a bus or the like.

The processor 301 may be, for example, a central processing unit (CPU) or a graphics processing unit (GPU). The processor 301 may also be a field programmable gate array (FPGA) or an application specific integrated circuit (ASIC). A plurality of processors 301 may be provided in the information processing device 300. In addition, the plurality of processors 301 may perform processing in a distributed manner. The processor 301 reads a program stored in the ROM 303 and the storage medium 304 into the RAM 302 and executes the program to perform arithmetic processing, control of each unit of the information processing device 300, and the like.

The RAM 302 is a volatile storage medium and functions as a work memory when the processor 301 executes a program. The ROM 303 is a nonvolatile storage medium, and stores firmware and the like necessary for the operation of the information processing device 300. The storage medium 304 is a nonvolatile storage medium such as a hard disk drive (HDD), a solid state drive (SSD), an optical disk, or a magneto-optical disk. The storage medium 304 stores programs, image data, and the like used in the processing of the embodiment. The function of storing information such as image data in the storage medium 304 may be provided not in the information processing device 300 but in another device.

The interface 305 may include a communication device that communicates with other devices by wire or wirelessly. The interface 305 acquires image data from the photoelectric conversion device 100. The interface 305 may include a user interface such as an input device or an output device.

FIG. 2 is a functional block diagram of the information processing device 300 according to the embodiment. The information processing device 300 includes a data input unit 311, a weighting unit 312, an optical flow calculation unit 313, and a reliability calculation unit 314.

The processor 301 executes a program to perform predetermined arithmetic processing. Accordingly, the processor 301 realizes the functions of the weighting unit 312, the optical flow calculation unit 313, and the reliability calculation unit 314. The processor 301 controls the interface 305 to acquire image data from the photoelectric conversion device 100 by executing a program. Thus, the interface 305 functions as the data input unit 311.

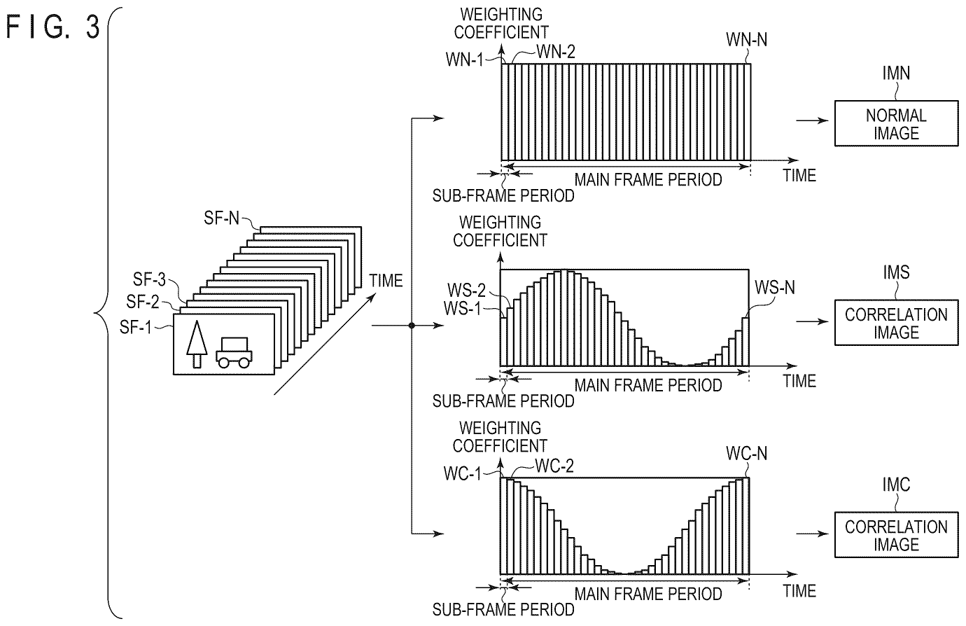

FIG. 3 is a schematic diagram illustrating the operation of the weighting unit 312 according to the embodiment. In the embodiment, it is assumed that the photoelectric conversion device 100 captures a normal image that is not weighted, and supplies the captured image to the data input unit 311 of the information processing device 300.

An image group including N sub-frames SF-1, SF-2, . . . , SF-N repeatedly captured by the photoelectric conversion device 100 is input in time series to the data input unit 311 (N is an integer of two or more). Each of the sub-frames SF-1, SF-2, . . . , SF-N is array data including a plurality of pixel values generated in a plurality of pixels. The N sub-frames SF-1, SF-2, . . . , SF-N are used to generate one image. One image generated by accumulating the pixel values of the N sub-frames SF-1, SF-2, . . . , SF-N is referred to as a main frame. An exposure period for generating one main frame is referred to as a main frame period. One main frame period is divided into N sub-frame periods. Each of the N sub-frame periods is an exposure period for generating one corresponding sub-frame. For example, it is assumed that the frame rate of the main frame is 30 fps, and the number of sub-frames constituting one main frame is 100. In this case, the length of one main frame period is obtained as about 33.3 ms from 1 s/30 fps, and the length of one sub-frame period is obtained as about 333 μs from 33.3 ms/100.

The weighting unit 312 respectively multiplies the pixel values of the N sub-frames SF-1, SF-2, . . . , SF-N by N weighting coefficients for each pixel, and accumulates the N values obtained by the multiplication to generate a main frame. Here, the N weighting coefficients are arranged in time series from a first weighting coefficient to an N-th weighting coefficient, and an i-th sub-frame SF-i is multiplied by an i-th weighting coefficient (i is an integer of one to N). The pixel values of the same pixel included in the N sub-frames SF-1, SF-2, . . . , SF-N can be represented by time-series pixel data of N elements, and the N weighting coefficients can be represented by a coefficient sequence of N elements. Therefore, processing of the weighting unit 312 can be rephrased as processing of calculating an inner product of the time-series pixel data including the time-series pixel values of the sub-frames SF-1, SF-2, . . . , SF-N as elements and the coefficient sequence including the weighting coefficients as elements.

A plurality of sets of weighting coefficients are used in the processing of the weighting unit 312. FIG. 3 illustrates an example of weighting using three sets of weighting coefficients WN-1, WN-2, . . . , WN-N, weighting coefficients WS-1, WS-2, . . . , WS-N, and weighting coefficients WC-1, WC-2, . . . , WC-N. The weighting coefficients WN-1, WN-2, . . . , WN-N have a constant value in the main frame period. The weighting coefficients WS-1, WS-2, . . . , WS-N change in a waveform of a sine function of one cycle in the main frame period. The weighting coefficients WC-1, WC-2, . . . , WC-N change in a waveform of a cosine function of one cycle in the main frame period. That is, the coefficient sequence (second coefficient sequence) including the weighting coefficients WN-1, WN-2, . . . , WN-N has a constant value with respect to the acquisition time of the corresponding pixel value. The coefficient sequence (first coefficient sequence) including the weighting coefficients WS-1, WS-2, . . . , WS-N and the coefficient sequence (third coefficient sequence) including the weighting coefficients WC-1, WC-2, . . . , WC-N periodically change with respect to the acquisition time of the corresponding pixel value. By performing weighting using the three sets of weighting coefficients as described above, three types of main frames having the same time resolution and having different weights with respect to time in the main frame period are generated.

A normal image IMN is generated by accumulating the inner product values (second inner products) calculated by the inner product operation of the weighting coefficients WN-1, WN-2, . . . , WN-N and the pixel values of the sub-frames SF-1, SF-2, . . . , SF-N. Since the weighting coefficients WN-1, WN-2, . . . , WN-N are constant values, the normal image IMN is similar to an image obtained by normal exposure without time weighting.

A correlation image IMS is generated by accumulating the inner product values (first inner products) calculated by the inner product operation of the weighting coefficients WS-1, WS-2, . . . , WS-N and the pixel values of the sub-frames SF-1, SF-2, . . . , SF-N. Since the weighting coefficients WS-1, WS-2, . . . , WS-N change with time according to the waveform of the sine function, information depending on time is added to the correlation image IMS.

A correlation image IMC is generated by accumulating the inner product values (third inner product) calculated by the inner product operation of the weighting coefficients WC-1, WC-2, . . . , WC-N and the pixel values of the sub-frames SF-1, SF-2, . . . , SF-N. Since the weighting coefficients WC-1, WC-2, . . . , WC-N change with time according to the waveform of the cosine function, information depending on time is added to the correlation image IMC by a phase different from that of the correlation image IMS.

The above-described weighting is an example, and for example, a waveform of a periodic function other than the sine function or the cosine function may be used for weighting. For example, a waveform used for weighting may be a triangular wave, a ramp wave, or a random pattern. The number of sets of weighting coefficients may be two, or may be four or more.

The weighting unit 312 generates the normal image IMN and the correlation images IMS and IMC by calculating the inner product of the weighting coefficients and the pixel values of the sub-frames as described above. The weighting unit 312 outputs the normal image IMN and the correlation images IMS and IMC to the optical flow calculation unit 313 and the reliability calculation unit 314.

The optical flow calculation unit 313 calculates a motion vector vₓ in the horizontal direction and a motion vector v_{y} in the vertical direction in the normal image IMN according to optical flow constraint expressions indicated in the following Expressions (1) to (5).

$$[ \begin{matrix}{v}_{x} \\ {v}_{y}\end{matrix} ] = {ω [ \begin{matrix}{a}_{11} & {a}_{12} \\ {a}_{21} & {a}_{22}\end{matrix} ]}^{- 1} [ \begin{matrix}{\int }_{- T / 2}^{T / 2} f ( x , y , t ) sin ω t dt \\ {\int }_{- T / 2}^{T / 2} f ( x , y , t ) cos ω t dt\end{matrix} ] \qquad ( 1 )$$

$${a}_{11} = {\partial }_{x} ( {( - 1 )}^{n} {\int }_{- T / 2}^{T / 2} f ( x , y , t ) dt - {\int }_{- T / 2}^{T / 2} f ( x , y , t ) cos ω t dt ) \qquad ( 2 )$$

$${a}_{12} = {\partial }_{y} ( {( - 1 )}^{n} {\int }_{- T / 2}^{T / 2} f ( x , y , t ) dt - {\int }_{- T / 2}^{T / 2} f ( x , y , t ) cos ω t dt ) \qquad ( 3 )$$

$${a}_{21} = {\partial }_{x} {\int }_{- T / 2}^{T / 2} f ( x , y , t ) sin ω t dt \qquad ( 4 )$$

$${a}_{22} = {\partial }_{y} {\int }_{- T / 2}^{T / 2} f ( x , y , t ) sin ω t dt \qquad ( 5 )$$

Here, the term of the time integration of f(x,y,t) in Expressions (2) and (3) corresponds to the normal image IMN. The term of the time integration of f(x,y,t) sin ωt in Expressions (1), (4), and (5) corresponds to the correlation image IMS. The term of the time integration of f(x,y,t) cos ωt in Expressions (1), (2), and (3) corresponds to the correlation image IMC. In the Expressions (2) to (5), the difference component ∂g in the horizontal direction of the normal image IMN and the difference component ∂y in the vertical direction of the normal image IMN can be calculated using a Sobel filter or the like.

The reliability calculation unit 314 calculates a reliability of each pixel using the normal image IMN and the correlation images IMS and IMC. The reliability calculation unit 314 outputs the calculated reliability for each pixel in the form of a reliability map, for example.

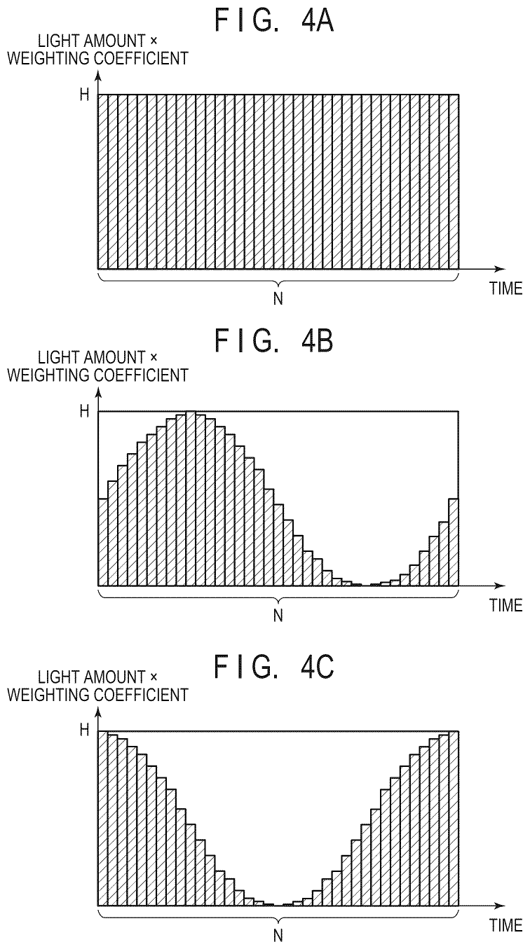

FIGS. 4A, 4B, and 4C are graphs illustrating the inner product operation according to the embodiment. FIGS. 4A, 4B, and 4C illustrate temporal changes in product of the light amount and the weighting coefficient over the main frame period in cases where the above-described three types of weighting are performed on the output signals of one pixel. In the examples of FIGS. 4A, 4B, and 4C, it is assumed that the object does not move in the main frame period and light of a constant light amount is incident on the photoelectric conversion device 100.

FIG. 4A illustrates an example in which weighting is performed by the weighting coefficients WN-1, WN-2, . . . , WN-N having a constant value. Here, it is assumed that the weighting coefficients WN-1, WN-2, . . . , WN-N are all one, and the product of the light amount and the weighting coefficient is H in all sub-frame periods. In this case, the inner product value in the main frame period is HN. This corresponds to the sum of the areas of the hatched portions in FIG. 4A.

FIG. 4B illustrates an example in which weighting is performed by the weighting coefficients WS-1, WS-2, . . . , WS-N that change in the waveform of the sine function. Since the incident light amount is the same as in the case of FIG. 4A, the amplitude of the product of the light amount and the weighting coefficient is H. In this case, since the areas of the hatched portions in FIG. 4B are half of that in the example of FIG. 4A, 0.5 HN is obtained. Therefore, the inner product value in the main frame period when weighting is performed by the waveform of the sine function is 0.5 HN.

FIG. 4C illustrates an example in which weighting is performed by the weighting coefficients WC-1, WC-2, . . . , WC-N that change in the waveform of the cosine function. Since the incident light amount is the same as in the case of FIG. 4A, the amplitude of the product of the light amount and the weighting coefficient is H. In this case, since the areas of the hatched portions in FIG. 4C are half of that in the example of FIG. 4A, 0.5 HN is obtained. Therefore, the inner product value in the main frame period when weighting is performed by the waveform of the cosine function is 0.5 HN.

When the amount of incident light in the main frame period is constant, the relationship of the following Expression (6) holds among the inner product value Pₙₒᵣ obtained by weighting a constant value, the inner product value Pₛᵢₙ obtained by weighting the sine function, and the inner product value P_{cos} obtained by weighting the cosine function.

$${P}_{s i n} = {P}_{c o s} = 0.5 \times {P}_{n o r} \qquad ( 6 )$$

Expression (6) indicates that the ratio of the inner product value Pₛᵢₙ to the inner product value Pₙₒᵣ is 0.5, and the ratio of the inner product value P_{cos} to the inner product value Pₙₒᵣ is 0.5. In the pixel satisfying Expression (6), since the amount of incident light in the main frame period is constant, the pixel value of the sub-frame does not change with time. This situation typically occurs when an object at the coordinates of the pixel is stationary. Even if the object at the coordinates of the pixel is moving, an optical flow that cannot be distinguished from a state in which the object is stationary is calculated. Therefore, when Expression (6) is satisfied, or when the inner product values Pₙₒᵣ, Pₛᵢₙ, and P_{cos} close to Expression (6) are obtained, the calculation accuracy of the optical flow decreases. On the other hand, when the inner product values Pₙₒᵣ, Pₛᵢₙ, and P_{cos} away from the condition of Expression (6) are obtained, there is a high possibility that the object is moving at the coordinates of the pixel, and the optical flow can be calculated with high accuracy.

Therefore, it is possible to obtain an index indicating a calculation accuracy of the optical flow by calculating a reliability defined by an expression indicating whether the inner product values Pₙₒᵣ, Pₛᵢₙ, and P_{cos} have a relationship close to the relational expression of the Expression (6). Specifically, as an example of an index of the calculation accuracy of the optical flow, a reliability R₁ of the following Expression (7) can be given.

$${R}_{1} = \vert {P}_{s i n} + {P}_{c o s} - {P}_{n o r} \vert \qquad ( 7 )$$

The expression in the absolute value symbol of the Expression (7) is to subtract the inner product value Pₙₒᵣ from the sum of the inner product value Pₛᵢₙ and the inner product value P_{cos}, and when the relationship among the values of the inner product values Pₙₒᵣ, Pₛᵢₙ, and P_{cos} is close to the Expression (6), the value in the absolute value symbol is close to zero. Therefore, as the reliability R₁ is closer to zero, there is a high possibility that the coordinates of the pixel are in the still region, and the calculation accuracy of the optical flow is low. In addition, the higher the reliability R₁, the higher the possibility that the coordinates of the pixel are in the moving region. By calculating the reliability R₁ for each of the plurality of pixels, it is possible to generate a reliability map in which the values of the reliability for respective pixels are mapped in a matrix.

The expression that can be used to calculate the reliability is not limited to the Expression (7), and an expression that can evaluate the closeness of the inner product values Pₙₒᵣ, Pₛᵢₙ, and P_{cos} to the Expression (6) can be used as appropriate. For example, a reliability R₂ of the following Expression (8) may be used.

$${R}_{2} = \vert 2 {P}_{s i n} - {P}_{n o r} \vert \times \vert 2 {P}_{c o s} - {P}_{n o r} \vert \qquad ( 8 )$$

The reliability R₂ is closer to zero as the value of the ratio of the inner product value Pₛᵢₙ to the inner product value Pₙₒᵣ or the value of the ratio of the inner product value P_{cos} to the inner product value Pₙₒᵣ is closer to 0.5. When both of these ratios are close to 0.5, the reliability R₂ is much closer to zero. That is, Expression (8) is an index for evaluating the closeness between the inner product value Pₛᵢₙ and the inner product value P_{cos} in addition to the condition of Expression (7).

The reliability map based on the optical flow calculated by the optical flow calculation unit 313 and the reliability calculated by the reliability calculation unit 314 may be used for image processing. The image processing may be, for example, processing of evaluating the motion of the object based on the optical flow and the reliability map. The image processing using the optical flow and the reliability map may be performed in the information processing device 300 or may be performed in another information processing device outside the information processing device 300.

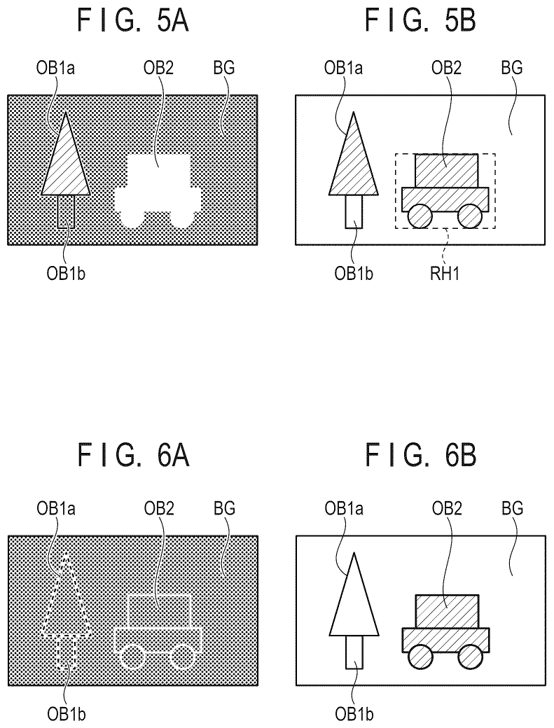

FIG. 5A is a diagram illustrating an example of the reliability map according to the embodiment, and FIG. 5B is a diagram illustrating an example of the optical flow map according to the embodiment. FIGS. 5A and 5B illustrate a two-dimensional distribution of reliabilities and a two-dimensional distribution of optical flows generated from a moving image, respectively. The imaging range of FIGS. 5A and 5B includes a tree, a vehicle OB2, and a background BG. The tree is divided into a leaf portion OB1a and a trunk portion OB1b. The vehicle OB2 is traveling at a predetermined speed. The leaf portion OB1a moves by receiving wind, and the trunk portion OB1b does not move.

FIG. 5A illustrates a distribution of the magnitude of the reliability. Since the vehicle OB2 is moving at a relatively high speed, a high value of reliability is obtained in the region of the vehicle OB2. Since the leaf portion OB1a moves at a relatively low speed, an intermediate value of reliability is obtained. Since the trunk portion OB1b and the background BG do not move, a small value of reliability is obtained. In the reliability map, the position within the imaging range and the reliability at each position are associated with each other.

For example, the moving body region can be detected by a region extraction method such as extracting a high-reliability region in which reliability equal to or greater than a predetermined value is obtained from the reliability map obtained in this manner. In the case of an image obtained by photographing the vehicle OB2 traveling as illustrated in FIG. 5A, an approximate range including the vehicle OB2 traveling can be detected by detecting a rectangular region including the moving body region.

FIG. 5B illustrates a high reliability region RH1 extracted from the reliability map in a state where the high reliability region RH1 is superimposed on the optical flow map. The hatched portions in FIG. 5B are regions in which the reliability is intermediate or higher and there is a high possibility that the object is moving. In the hatched regions, the optical flow can be calculated with relatively high accuracy. In the high reliability region RH1, the optical flow can be calculated with higher accuracy.

The optical flow calculation unit 313 may omit the optical flow calculation in a region other than the high reliability region RH1. This reduces the computation load and processing time. As described above, the optical flow calculation unit 313 may control execution or non-execution of the optical flow calculation based on the calculation result of the reliability in the reliability calculation unit 314. For example, operation control may be employed in which the optical flow calculation unit 313 performs the optical flow calculation when the reliability is equal to or greater than a predetermined threshold value, and does not perform the optical flow calculation when the reliability is less than the predetermined threshold value. In addition, the calculation result of the reliability in the reliability calculation unit 314 may be used for control of execution or non-execution of image processing other than the optical flow calculation or recognition processing of the captured image.

In the embodiment, in image processing in which weighting is performed by calculating an inner product of time-series pixel data including pixel values of sub-frames as elements and a coefficient sequence including weight coefficients as elements, reliability is acquired based on two or more inner product values obtained using a plurality of different weight coefficients. This reliability indicates the magnitude of the possibility that the pixel value is changing with time, and may be used in other processing as information indicating the calculation accuracy of the optical flow. Therefore, according to the embodiment, the information processing device 300 capable of more suitably acquiring the information related to the calculation accuracy of the optical flow is provided.

### Second Embodiment

In the embodiment, a modification of the processing of calculating the reliability and determination will be described. In the embodiment, description of elements common to those of the first embodiment may be omitted or simplified.

In the first embodiment, an example in which the reliability is calculated as a continuous value using a mathematical expression is indicated. On the other hand, in the embodiment, an example in which the determination result of the reliability is output as binary data by comparing the calculated reliability with a threshold value will be described.

In the embodiment, the reliability calculation unit 314 calculates reliabilities R₃ and R₄ by the following Expressions (9) and (10).

$${R}_{3} = \vert 2 {P}_{s i n} - {P}_{n o r} \vert \qquad ( 9 )$$

$${R}_{4} = \vert 2 {P}_{c o s} - {P}_{n o r} \vert \qquad ( 10 )$$

The expression for calculating the reliability R₃ includes the inner product value Pₙₒᵣ obtained by constant weighting and the inner product value Pₛᵢₙ obtained by weighting of the sine function. The reliability R₃ is closer to zero as the value of the ratio of the inner product value Pₛᵢₙ to the inner product value Pₙₒᵣ is closer to 0.5. The calculation expression of the reliability R₄ includes the inner product value Pₙₒᵣ obtained by constant weighting and the inner product value P_{cos} obtained by weighting of the cosine function. The reliability R₄ is closer to zero as the value of the ratio of the inner product value P_{cos} to the inner product value Por is closer to 0.5.

Then, the reliability calculation unit 314 determines whether both the reliability R₃ and the reliability R₄ are less than a threshold value TH, and outputs the determination result as binary data. For example, the reliability calculation unit 314 outputs the logical value “0” when both the reliability R₃ and the reliability R₄ are less than the threshold value TH, and outputs the logical value “1” when at least one of the reliability R₃ and the reliability R₄ is equal to or greater than the threshold value TH.

The logical value of “0” indicates that the coordinates of the pixel are likely to be in the still region and the calculation accuracy of the optical flow is low. The logical value “1” indicates that the coordinates of the pixel are likely to be the moving region and the calculation accuracy of the optical flow is high. That is, the reliability calculation unit 314 of the embodiment binarizes and outputs the reliability information. By calculating the above-described logical value for each of the plurality of pixels, it is possible to generate a reliability map in which the reliability determination results for each pixel are mapped in a matrix. The threshold value TH may be a value set in advance, or may be dynamically set based on information of an input image, information of an external imaging environment, or the like. Since the magnitude of the reliability may change depending on a situation other than the motion of the object (for example, brightness of the imaging environment), the determination accuracy may be improved by acquiring information from the input image, the imaging environment, or the like and dynamically setting the threshold value TH.

For example, the optical flow calculation unit 313 may calculate a representative vector of the optical flow while excluding an output signal of a pixel whose logical value of the reliability map is “0”. In addition, interpolation processing may be performed on a pixel whose logical value of the reliability map is “0” using output signals of peripheral pixels whose logical values are “1”. The optical flow calculation unit 313 may exclude an output signal of a pixel whose logical value of the reliability map is “0” from the arithmetic processing.

FIG. 6A is a diagram illustrating an example of the reliability map according to the embodiment, and FIG. 6B is a diagram illustrating an example of the optical flow map according to the embodiment. The types of objects in the image are substantially the same as those in the first embodiment, but in the embodiment, it is assumed that there is little color change due to texture, gradation, or the like in the body panel surface of the vehicle OB2. In a case where the color change in a certain region of the object is small, the amount of light incident on the pixel of interest of the photoelectric conversion device 100 does not change with time even when the object moves, and thus the calculation accuracy of the optical flow may decrease. FIG. 6A illustrates an example of the reliability map obtained in this situation.

Since the vehicle OB2 is moving at a relatively high speed, a logical value of “1” is obtained in the region of the contour of the vehicle OB2. However, a logical value of “0” is obtained in other regions. In other words, in the embodiment, the region where the highly accurate optical flow is calculated is only the contour portion of the vehicle OB2. Therefore, in order to obtain an appropriate optical flow, processing of interpolating the optical flow in an inner portion of the vehicle OB2 is necessary. As a specific example, since the optical flow is calculated with high accuracy in the contour portion of the vehicle OB2, processing of propagating a vector of the optical flow from the contour toward an area inside the vehicle OB2 is performed. To this processing, for example, morphological processing used in the field of image analysis may be applied.

In the embodiment, the reliability is acquired in the same manner as in the first embodiment. In addition, in the embodiment, by comparing the reliability with the threshold value, it is possible to acquire data indicating the determination result of the reliability. Therefore, according to the embodiment, the information processing device 300 capable of more suitably acquiring the information related to the calculation accuracy of the optical flow is provided.

### Third Embodiment

In the embodiment, a modification of the processing of calculating the reliability will be described. In the embodiment, description of elements common to those of the first embodiment may be omitted or simplified.

In the first embodiment and the second embodiment, the reliabilities R₁, R₂, R₃, and R₄ based on the inner product values Pₙₒᵣ, Pₛᵢₙ, and P_{cos} are exemplified. In the calculation of the reliabilities, normalization using the inner product value Pₙₒᵣ may be performed.

First, an example in which normalization is performed at the time of calculation of reliability in the processing of the second embodiment will be described. The reliability calculation unit 314 calculates reliabilities R₅ and R₆ by the following Expressions (11) and (12).

$${R}_{5} = \frac{\vert 2 {P}_{s i n} - {P}_{n o r} \vert}{{P}_{n o r}} \qquad ( 11 )$$

$${R}_{6} = \frac{\vert 2 {P}_{c o s} - {P}_{n o r} \vert}{{P}_{n o r}} \qquad ( 12 )$$

The calculation expressions of the reliabilities R₅ and R₆ are obtained by normalizing the Expression (9) and (10) by dividing them by the inner product value Pₙₒᵣ, respectively. Then, the reliability calculation unit 314 determines whether both the reliabilities R₅ and R₆ are less than the threshold value TH, and outputs the determination result as binary data. For example, the reliability calculation unit 314 outputs the logical value “0” when both the reliability R₅ and the reliability R₆ are less than the threshold value TH, and outputs the logical value “1” when at least one of the reliability R₅ and the reliability R₆ is equal to or greater than the threshold value TH.

When the reliabilities R₃ and R₄ of the second embodiment are used, the reliabilities are higher as the imaging environment are brighter. Therefore, it may be necessary to dynamically change the threshold value TH in accordance with the brightness of the imaging environment in order to secure the determination accuracy. On the other hand, since the reliabilities R₅ and R₆ of the embodiment are normalized by the inner product value Por, it is not necessary to change the threshold value TH according to the brightness of the imaging environment, and determination can be performed by a constant threshold value. Therefore, according to the embodiment, the information processing device 300 capable of more suitably acquiring the information related to the calculation accuracy of the optical flow is provided.

In the processing of the first embodiment, normalization may be performed when calculating the reliability. In this modification, the reliability calculation unit 314 calculates the reliability R₇ or the reliability R₈ by the following Expression (13) or (14).

$${R}_{7} = \frac{\vert {P}_{s i n} + {P}_{c o s} - {P}_{n o r} \vert}{{P}_{n o r}} \qquad ( 13 )$$

$${R}_{8} = \frac{\vert 2 {P}_{s i n} - {P}_{n o r} \vert \times \vert 2 {P}_{c o s} - {P}_{n o r} \vert}{{P}_{n o r}} \qquad ( 14 )$$

The calculation expressions of the reliabilities R₇ and R₈ are obtained by normalizing by dividing the Expression (7) and (8) by the inner product value Por, respectively. Also in these modification examples, reliability independent of the brightness of the imaging environment can be obtained as in Expression (11) and (12).

### Fourth Embodiment

In the embodiment, a modification of the photoelectric conversion device 100 will be described. In the embodiment, description of elements common to the first to third embodiments may be omitted or simplified.

In the first to third embodiments, examples in which the inner product operation is performed in the information processing device 300 and the normal image and the correlation image are generated have been described. However, the processing of generating the normal image and the correlation image may be performed outside the information processing device 300. In the embodiment, an example in which a signal generation operation corresponding to the inner product calculation is performed in the photoelectric conversion device 100 will be described.

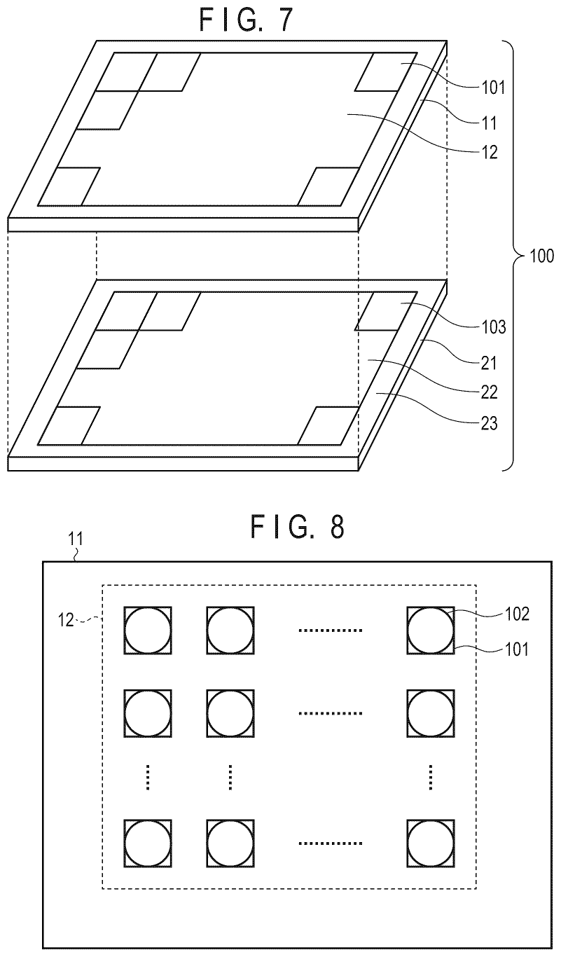

FIG. 7 is a schematic diagram illustrating an overall configuration of the photoelectric conversion device 100 according to the embodiment. The photoelectric conversion device 100 includes a sensor substrate 11 (first substrate) and a circuit substrate 21 (second substrate) stacked. The sensor substrate 11 and the circuit substrate 21 are electrically connected to each other. The sensor substrate 11 has a pixel region 12 in which a plurality of pixel circuits 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

FIG. 8 is a schematic block diagram illustrating an arrangement example of the sensor substrate 11. In the pixel region 12, a plurality of pixel circuits 101 are arranged to form a plurality of rows and a plurality of columns. Each of the plurality of pixel circuits 101 includes a photoelectric conversion unit 102 including an avalanche photodiode (hereinafter referred to as APD) as a photoelectric conversion element in the substrate.

Of the charge pairs generated in the APD, the conductivity type corresponding to the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

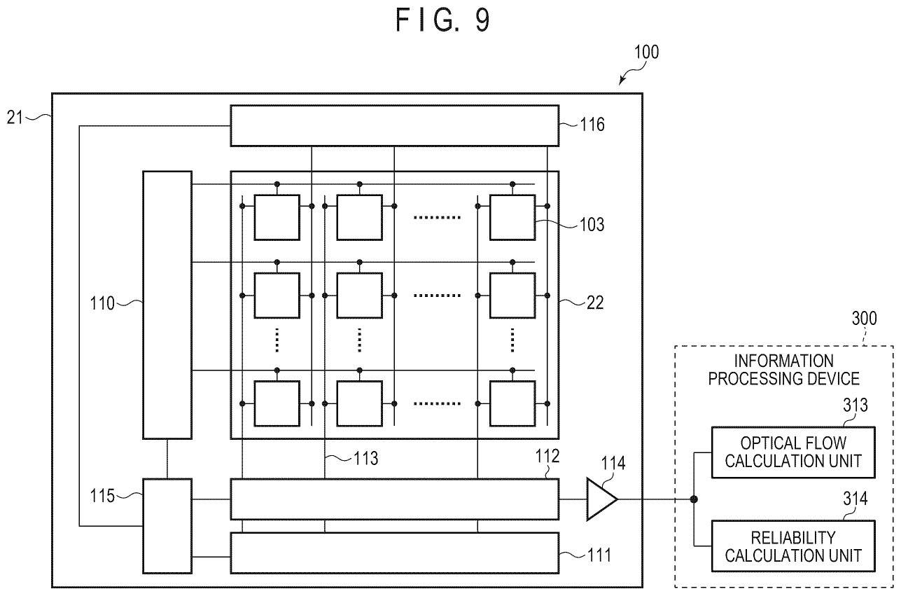

FIG. 9 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, a control signal generation unit 115, and a weight control unit 116. The plurality of photoelectric conversion units 102 illustrated in FIG. 8 and the plurality of pixel signal processing units 103 illustrated in FIG. 9 are electrically connected to each other via connection wirings provided for each pixel circuits 101.

The control signal generation unit 115 is a control circuit that generates control signals for driving the vertical scanning circuit 110, the horizontal scanning circuit 111, the reading circuit 112, and the weight control unit 116 and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixel circuit 101 is processed by the pixel signal processing unit 103. The pixel signal processing unit 103 acquires and holds a digital signal based on a pulse output from the APD included in the photoelectric conversion unit 102.

The weight control unit 116 controls a weighting coefficient (weighting amount) given to the output signal from the APD in the pixel signal processing unit 103. A reference signal including information on the weighting amount is supplied from the weight control unit 116 to each of the plurality of pixel signal processing units 103.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to the information processing device 300 via the output circuit 114 based on the control signal supplied from the control signal generation unit 115.

The information processing device 300 performs signal processing on a signal output from the photoelectric conversion device 100. The information processing device 300 may perform processing related to time correlation imaging using a signal output from the photoelectric conversion device 100. The processing related to the time correlation imaging includes the processing performed by the optical flow calculation unit 313 and the processing performed by the reliability calculation unit 314 described in the first to third embodiments.

The arrangement of the photoelectric conversion units 102 in the pixel region 12 may be one-dimensional. Further, the function of the pixel signal processing unit 103 does not necessarily have to be provided one by one in all the pixel circuits 101. For example, one pixel signal processing unit 103 may be shared by a plurality of pixel circuits 101. In this case, the pixel signal processing unit 103 sequentially processes the signals output from the photoelectric conversion units 102, thereby providing the function of signal processing to each pixel circuit 101.

As illustrated in FIGS. 8 and 9, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, the control signal generation unit 115, and the weight control unit 116 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 having the vertical scanning circuit 110, the horizontal scanning circuit 111, the reading circuit 112, the output circuit 114, the control signal generation unit 115, and the weight control unit 116 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 9. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

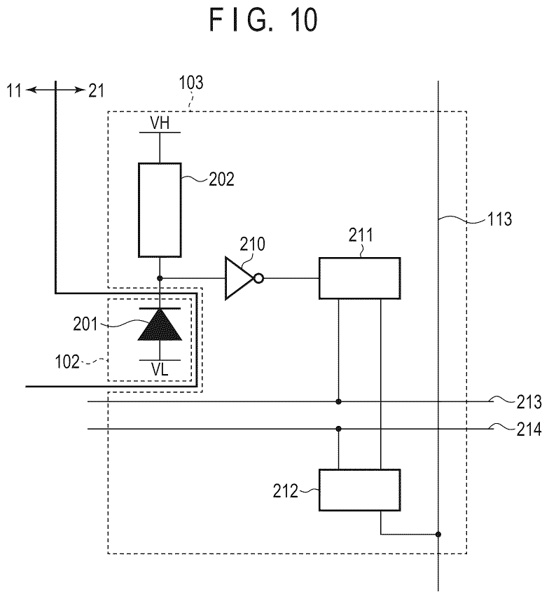

FIG. 10 is a schematic block diagram illustrating a configuration example of one pixel of the photoelectric conversion unit 102 and the pixel signal processing unit 103 according to the embodiment. FIG. 10 schematically illustrates a more specific configuration example including a connection relationship between the photoelectric conversion unit 102 arranged in the sensor substrate 11 and the pixel signal processing unit 103 arranged in the circuit substrate 21. In FIG. 10, driving lines between the vertical scanning circuit 110 and the pixel signal processing unit 103 in FIG. 9 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212. The pixel signal processing unit 103 may include at least one of the waveform shaping unit 210, the counter circuit 211, and the selection circuit 212.

The APD 201 generates a charge pair corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is-30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD may be used.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a transistor.

The waveform shaping unit 210 shapes the potential change of the cathode of the APD 201 obtained at the time of photon detection, and outputs a pulsed signal. For example, an inverter circuit is used as the waveform shaping unit 210. Although FIG. 10 illustrates an example in which one inverter is used as the waveform shaping unit 210, the waveform shaping unit 210 may be a circuit in which a plurality of inverters are connected in series, or may be another circuit having a waveform shaping effect.

The counter circuit 211 counts the pulsed signal output from the waveform shaping unit 210 and holds a digital signal indicating the count value. When a control signal is supplied from the vertical scanning circuit 110 through the driving line 213, the counter circuit 211 resets the signal held therein.

The selection circuit 212 is supplied with a control signal from the vertical scanning circuit 110 illustrated in FIG. 9 through the driving line 214 illustrated in FIG. 10. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 10, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

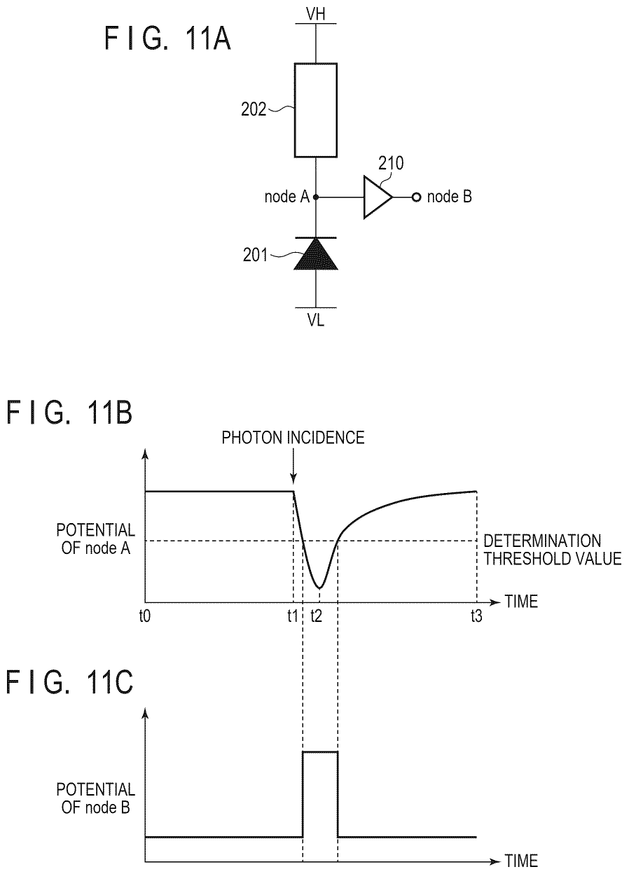

FIGS. 11A, 11B, and 11C are diagrams illustrating an operation of the APD 201 according to the embodiment. FIG. 11A is a diagram illustrating the APD 201, the quenching element 202, and the waveform shaping unit 210 in FIG. 10. As illustrated in FIG. 11A, the connection node of the APD 201, the quenching element 202, and the input terminal of the waveform shaping unit 210 is referred to as node A. Further, as illustrated in FIG. 11A, an output side of the waveform shaping unit 210 is referred to as node B.

FIG. 11B is a graph illustrating a temporal change in the potential of node A in FIG. 11A. FIG. 11C is a graph illustrating a temporal change in the potential of node B in FIG. 11A. During a period from time to t0 time t1, the voltage VH-VL is applied to the APD 201 in FIG. 11A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

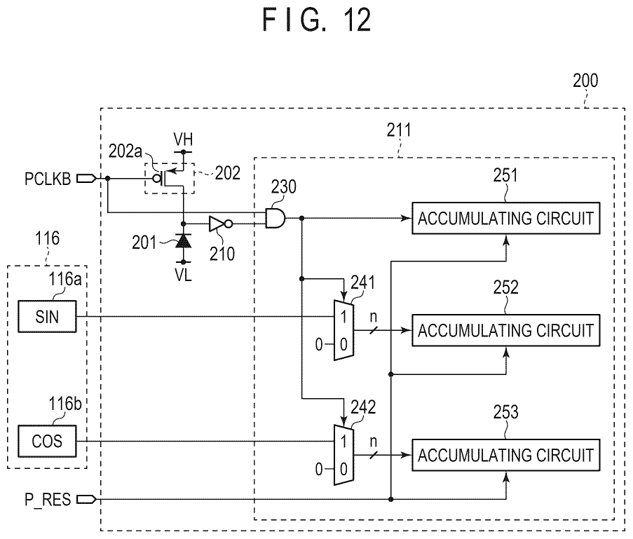

FIG. 12 is a diagram illustrating a configuration of a pixel according to the embodiment. FIG. 12 illustrates the photoelectric conversion unit 102 and the pixel signal processing unit 103 in FIG. 10 in more detail. Hereinafter, an element obtained by combining the photoelectric conversion unit 102 and the pixel signal processing unit 103 may be referred to as a pixel 200. In FIG. 12, elements having the same functions as those illustrated in FIG. 10 are denoted by the same reference numerals as those in FIG. 10, and descriptions of these elements may be omitted or simplified.

The pixel 200 includes an APD 201, a quenching element 202, a waveform shaping unit 210, and a counter circuit 211. The quenching element 202 has a P-type MOS transistor 202a. The counter circuit 211 includes an AND circuit 230, multiplexers 241 and 242, and accumulating circuits 251, 252, and 253. Signals PCLKB and P_RES are input to the pixel 200 from the vertical scanning circuit 110.

The signal PCLKB is input to a gate of the MOS transistor 202a. The voltage VH is supplied to a source of the MOS transistor 202a. A drain of the MOS transistor 202a is connected to the cathode of the APD 201 and the input terminal of the waveform shaping unit 210.

The signal PCLKB is, for example, a pulsed signal having a frequency of 1 MHz to 200 MHz. The number of pulses in one main frame period can be appropriately set according to the number of bits of the counter circuit 211. When the counter circuit 211 performs counting with 11 bits, the number of pulses in one main frame period is less than 2048. The signal PCLKB controls the timing of the recharge operation in the APD 201. When the signal PCLKB becomes the low level, the MOS transistor 202a is turned on, and the recharge operation is performed in the APD 201.

The signal PCLKB is input to a first input terminal of the AND circuit 230, and the output signal of the waveform shaping unit 210 is input to a second input terminal of the AND circuit 230. The AND circuit 230 outputs the logical product of the signal PCLKB and the output signal of the waveform shaping unit 210 to the accumulating circuit 251, a control terminal of the multiplexer 241, and a control terminal of the multiplexer 242.

The accumulating circuit 251 counts the number of pulses by accumulating the pulses of the signal input from the AND circuit 230. The accumulating circuit 251 holds a count value obtained by the counting. The count value held in the accumulating circuit 251 corresponds to the number of photons incident on the APD 201. That is, the count value corresponding to the inner product value when the weighting coefficient is a constant value is held in the accumulating circuit 251.

The weight control unit 116 includes a sine waveform generation unit 116a and a cosine waveform generation unit 116b. The sine waveform generation unit 116a generates a pulsed signal having a time-varying value according to the waveform of the sine function, with the main frame period as one cycle. The cosine waveform generation unit 116b generates a pulsed signal having a time-varying value according to the waveform of the cosine function, with the main frame period as one cycle. The sine waveform generation unit 116a outputs the pulsed signal to a first input terminal of the multiplexer 241 as a bus signal. The cosine waveform generation unit 116b outputs the pulsed signal to a first input terminal of the multiplexer 242 as a bus signal. A second input terminal of the multiplexer 241 and a second input terminal of the multiplexer 242 are connected to a ground potential line having a ground potential corresponding to a logical value of “0”.

The multiplexers 241 and 242 select the signal of the first input terminal (the “1” in FIG. 12) when the high-level signal is input to the control terminal, and select the signal of the second input terminal (the “O” in FIG. 12) when the low-level signal is input to the control terminal. An output signal of the multiplexer 241 is input to the accumulating circuit 252, and an output signal of the multiplexer 242 is input to the accumulating circuit 253.

Therefore, when the output signal of the AND circuit 230 is at the high level, the multiplexer 241 outputs the pulsed signal output from the sine waveform generation unit 116a to the accumulating circuit 252. The accumulating circuit 252 counts the number of pulses by counting up according to the value of the signal input from the multiplexer 241. The accumulating circuit 252 holds the count value obtained by the counting. When the output signal of the AND circuit 230 is at the low level, the multiplexer 241 outputs a signal having a logical value of “0” to the accumulating circuit 252. In this case, the count-up is not performed. Through these operations, the accumulating circuit 252 holds a count value obtained by performing weighting corresponding to the weighting coefficients WS-1, WS-2, . . . , WS-N of FIG. 3 on the number of photons incident on the APD 201.

When the output signal of the AND circuit 230 is at the high level, the multiplexer 242 outputs the pulsed signal output from the cosine waveform generation unit 116b to the accumulating circuit 253. The accumulating circuit 253 counts the number of pulses by counting up according to the value of the signal input from the multiplexer 242. The accumulating circuit 253 holds the count value obtained by the counting. When the output signal of the AND circuit 230 is at the low level, the multiplexer 242 outputs a signal having a logical value of “0” to the accumulating circuit 253. In this case, the count-up is not performed. Through these operations, the accumulating circuit 253 holds a count value obtained by performing weighting corresponding to the weighting coefficients WC-1, WC-2, . . . , WC-N of FIG. 3 on the number of photons incident on the APD 201.

At the same time, the weighting coefficient of the sine waveform for the signal input to the accumulating circuit 252 and the weighting coefficient of the cosine waveform for the signal input to the accumulating circuit 253 are different from each other. It is not essential that the weighting coefficients of both are different at all times within one main frame period, and the weighting coefficients of both may be the same at some times.

The vertical scanning circuit 110 outputs the signal P_RES to the accumulating circuits 251, 252, and 253. When the signal P_RES becomes the high level, the count value held in each of the accumulating circuits 251, 252, and 253 is reset to an initial value. At the time when the main frame period illustrated in FIG. 3 starts, the signal P_RES becomes the high level and then becomes the low level. By this operation, the accumulating circuits 251, 252, and 253 are reset every time the main frame period starts, and the count operation of the main frame period starts. Therefore, the accumulating circuits 251, 252, and 253 perform weighted accumulation for accumulating the count values obtained by weighting from the start to the end of one main frame period.

As described above, different count values are held in the accumulating circuits 251, 252, and 253. The count value held in the accumulating circuit 251 corresponds to the number of photons incident on the APD 201. This is equivalent to the case where weighting is performed by a constant weighting coefficient. In other words, the accumulating circuit 251 holds a count value obtained by weighting the number of photons incident on the APD 201 by the constant weighting coefficient WN-1, WN-2, . . . , WN-N.

The accumulating circuit 252 holds a count value obtained by weighting the number of photons incident on the APD 201 by the weighting coefficients WS-1, WS-2, . . . , WS-N that change in the waveform of the sine function. The accumulating circuit 253 holds a count value obtained by weighting the number of photons incident on the APD 201 by the weighting coefficients WC-1, WC-2, . . . , WC-N that change in the waveform of the cosine function. In this way, the accumulating circuits 251, 252, and 253 hold count values that are weighted differently with respect to the output of the APD 201. These count values respectively correspond to the pixel value of the normal image IMN, the pixel value of the correlation image IMS, and the pixel value of the correlation image IMC in FIG. 3.

As described above, in the embodiment, the signal generation operation corresponding to the inner product operation in the first to third embodiments is performed in the photoelectric conversion device 100 by holding the count values with different weightings in the accumulating circuits 251, 252, and 253. Therefore, in the embodiment, the photoelectric conversion device 100 capable of realizing signal output for time correlation imaging is provided. In addition, as in the first to third embodiments, the reliability calculation unit 314 calculates the reliability for the output signal of the photoelectric conversion device 100, so that it is possible to suitably acquire information related to the calculation accuracy of the optical flow. Similarly to the first to third embodiments, the optical flow calculation unit 313 can calculate the optical flow for the output signal of the photoelectric conversion device 100.

Further, in the embodiment, the photoelectric conversion device 100 includes the APD 201 having high detection accuracy of incident light, and time correlation imaging can be performed on the output signal of the APD 201. Therefore, it is possible to suitably perform time correlation imaging in a low-luminance shooting scene.

The sine waveform generation unit 116a and the cosine waveform generation unit 116b may be provided corresponding to each of the plurality of pixels 200. The plurality of pixels 200 may be divided into a plurality of pixel blocks, and in this case, the sine waveform generation unit 116a and the cosine waveform generation unit 116b may be provided corresponding to each of the plurality of pixel blocks.

In addition, the pixel 200 may have a configuration in which a photodiode used in a general CMOS image sensor is used instead of the avalanche photodiode. In such a pixel, the amount of light is converted into an analog electrical signal. In this case, the analog electrical signal is weighted by multiplying the analog reference signal to acquire a correlation image.

### Fifth Embodiment

In the embodiment, a modification of the pixel configuration of the photoelectric conversion device 100 according to the fourth embodiment will be described. In the embodiment, description of elements common to the first to fourth embodiments may be omitted or simplified.

In the first to fourth embodiments, three values are generated by performing weighting with the constant value, weighting with the sine function, and weighting with the cosine function on the output signal of one photoelectric conversion unit. On the other hand, in the embodiment, a configuration in which any one of weighting with the constant value, weighting with the sine function, and weighting with the cosine function is performed on an output signal of one pixel will be described.

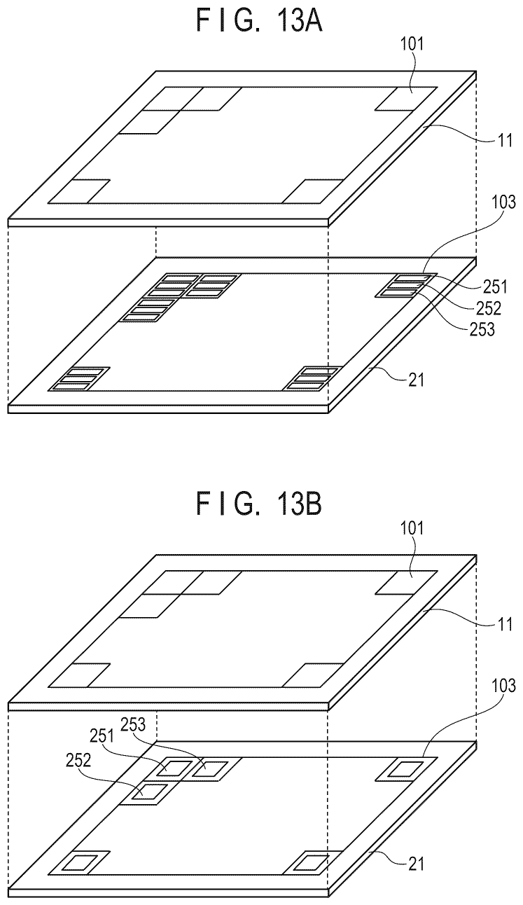

FIGS. 13A and 13B are schematic diagrams illustrating the configuration of the photoelectric conversion device 100 according to the embodiment. FIG. 13A illustrates a configuration of the sensor substrate 11 and the circuit substrate 21 according to the fourth embodiment as a comparative example with respect to the embodiment. The plurality of pixel circuits 101 are arranged on the sensor substrate 11, and the plurality of pixel signal processing units 103 are arranged on the circuit substrate 21 so as to respectively correspond to the plurality of pixel circuits 101. As described in the fourth embodiment, three accumulating circuits 251, 252, and 253 are arranged in one pixel signal processing unit 103. As a result, three signals weighted by the constant value, weighted by the sine function, and weighted by the cosine function are obtained from one pixel, and three kinds of signals used for calculation of reliability can be obtained from one pixel. However, in this circuit configuration, it is necessary to arrange three counter circuits for one pixel, which may increase the circuit scale per pixel.

FIG. 13B illustrates the configuration of the sensor substrate 11 and the circuit substrate 21 in the embodiment. In the embodiment, one of the three accumulating circuits 251, 252, and 253 is arranged in one pixel signal processing unit 103. That is, in the embodiment, three types of pixels, which include a pixel to be weighted by the constant value, a pixel to be weighted by the sine function, and a pixel to be weighted by the cosine function, are arranged in a two-dimensional array. In this circuit configuration, since one counter circuit is arranged for one pixel, the circuit scale per pixel can be reduced as compared with the comparative example of FIG. 13A.

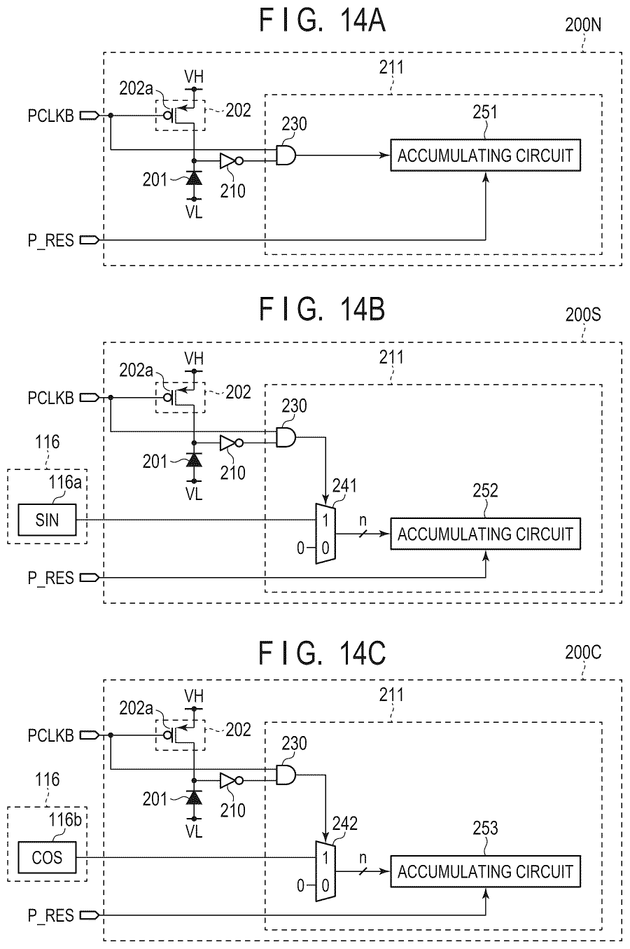

FIGS. 14A, 14B, and 14C are diagrams illustrating a configuration of pixels according to the embodiment. Each of FIGS. 14A, 14B, and 14C illustrates the photoelectric conversion unit 102 and the pixel signal processing unit 103 in FIG. 13B in more detail. Hereinafter, an element obtained by combining the photoelectric conversion unit 102 and the pixel signal processing unit 103 including the accumulating circuit 251 may be referred to as a pixel 200N. Similarly, an element obtained by combining the photoelectric conversion unit 102 and the pixel signal processing unit 103 including the accumulating circuit 252 may be referred to as a pixel 200S, and an element obtained by combining the photoelectric conversion unit 102 and the pixel signal processing unit 103 including the accumulating circuit 253 may be referred to as a pixel 200C.

The pixel 200N has a configuration in which elements related to the multiplexers 241 and 242 and the accumulating circuits 252 and 253 are omitted from the configuration of the pixel 200 in FIG. 12. Therefore, the pixel 200N generates a count value weighted by the constant value.

The pixel 200S has a configuration in which elements related to the multiplexer 242 and the accumulating circuits 251 and 253 are omitted from the configuration of the pixel 200 in FIG. 12. Therefore, the pixel 200S generates a count value weighted by the sine function.

The pixel 200C has a configuration in which elements related to the multiplexer 241 and the accumulating circuits 251 and 252 are omitted from the configuration of the pixel 200 in FIG. 12. Therefore, the pixel 200C generates a count value weighted by the cosine function.

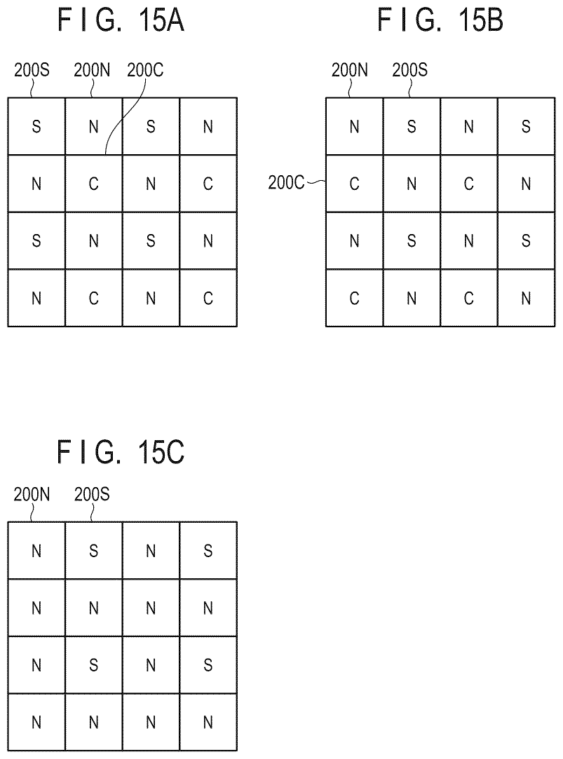

FIGS. 15A, 15B, and 15C are diagrams illustrating an arrangement of pixels according to the embodiment. Each of FIGS. 15A, 15B, and 15C illustrates four rows and four columns of an array in which a plurality of pixels are repeatedly arranged. The pixel arrangement of FIG. 15A has a repetitive arrangement in which one pixel 200S, two pixels 200N, and one pixel 200C constitute one unit. The pixel 200S is arranged on the upper left of one unit, the pixels 200N are arranged on the upper right and lower left of one unit, and the pixel 200C is arranged on the lower right of one unit. The pixel arrangement of FIG. 15B also has a repetitive arrangement in which one pixel 200S, two pixels 200N, and one pixel 200C are set as one unit. FIG. 15B illustrates a horizontally flipped arrangement of FIG. 15A. Thus, the order of the arrangement of the pixels 200S, 200N, and 200C can be changed as appropriate.

In the configuration of the embodiment, a signal obtained from one pixel is only one kind of signal obtained by one kind of weighting. For example, a signal weighted by the constant value and a signal weighted by the cosine function are not output from the pixel 200S. In addition, a signal weighted by the sine function and a signal weighted by the cosine function are not output from the pixel 200N. Therefore, when the normal image IMN and the correlation images IMS and IMC are generated, information of some pixels is lost. In addition, since the inner product values of the pixels at the same position cannot be used when calculating the reliability, the accuracy of calculating the reliability may decrease. Therefore, processing of calculating the pixel value of the missing coordinates by interpolation using the pixel values of the surroundings may be performed. In this interpolation processing, an algorithm used for demosaic processing on output signals from an imaging device in which red, green, and blue color filters are arranged in a Bayer arrangement or the like can be applied. Examples of such algorithms include the nearest neighbor method and the bilinear method.

Further, instead of or in addition to the above-described interpolation processing, control may be performed to dynamically change the value of the threshold value TH described in the second embodiment and the third embodiment in accordance with the signal generated by the photoelectric conversion device 100 or the imaging environment. For example, it is assumed that a defective pixel that always outputs a high pixel value (white point defective pixel) or a defective pixel that always outputs a low pixel value (black point defective pixel) exists due to a pixel defect or the like. If the pixel 200N is a defective pixel, the pixel value of the pixel 200N and the pixel values of the surrounding pixels 200S and 200C are significantly different from each other. In such a situation, high reliability can be calculated even when there is no motion in the object. Therefore, in a case where it is known from the output signal or the information of the imaging environment that a defective pixel exists as described above, the possibility of erroneous determination can be reduced by setting the value of the threshold value TH higher in the vicinity of the defective pixel than in other regions.

In the pixel arrangements of FIGS. 15A and 15B, the occupation ratio of the pixel 200N is greater than both the occupation ratio of the pixel 200S and the occupation ratio of the pixel 200C. That is, in the entire array in which a plurality of pixels are arranged, the number of first photoelectric conversion units used to generate the normal image IMN is greater than the number of second photoelectric conversion units used to generate the correlation image IMS (or the correlation image IMC). In such a pixel arrangement, the amount of information of the normal image IMN is greater than each of the amount of information of the correlation image IMS and the amount of information of the correlation image IMC. Therefore, the pixel arrangements of FIGS. 15A and 15B are more effective in a use case in which the image quality of the normal image IMN is prioritized over the image quality of the correlation images IMS and IMC. However, in some cases, such as when the images are mainly used for the optical flow calculation, the image quality of the correlation images IMS and IMC is prioritized over the image quality of the normal image IMN. In such a case, a pixel arrangement in which the occupation ratio of the pixel 200S and the occupation ratio of the pixel 200C are greater than the occupation ratio of the pixel 200N may be employed.

The pixel array of FIG. 15C has a repetitive arrangement in which one pixel 200S and three pixels 200N are one unit. Thus, a pixel arrangement in which one of the pixels 200C or the pixel 200S is arranged may be employed. The pixel arrangement of FIG. 15C is more effective in a use case where the image quality of the normal image IMN is prioritized than the pixel arrangement of FIGS. 15A and 15B. In this case, when the incident light amount in the main frame period is constant, a relationship of the following Expression (15) is satisfied between the inner product value Pₙₒᵣ obtained by weighting the constant value and the inner product value Pₛᵢₙ obtained by weighting the sine function.

$${P}_{s i n} = 0.5 \times {P}_{n o r} \qquad ( 15 )$$

In this case, for example, the following Expression (16) can be used as a reliability R₉.

$${R}_{9} = \vert 2 {P}_{s i n} - {P}_{n o r} \vert \qquad ( 16 )$$

The reliability R₉ is closer to zero as the value of the ratio of the inner product value Pₛᵢₙ to the inner product value Pₙₒᵣ is closer to 0.5.

As described above, in the embodiment, any one of the weighting by the constant value, the weighting by the sine function, and the weighting by the cosine function is performed on the output signal of one pixel. Accordingly, since one counter circuit is arranged for one pixel, the circuit scale per pixel can be reduced as compared with the pixel configuration of the fourth embodiment.

Although the first to fifth embodiments exemplify a case where the number of types of weighting used to calculate the reliability is three or two, the number of types of weighting may be any number equal to or greater than two. When the Expressions (6) and (15) are generalized, they can be expressed by the following Expression (17).

$${P}_{f 1} : {P}_{f 2} : … : {P}_{f m} = \sum f 1 : \sum f 2 : … : \sum fm \qquad ( 17 )$$

Here, the number m of types of weighting in Expression (17) is an integer equal to or greater than two, the value of the j-th inner product acquired using the j-th type of weighting coefficient fj is an inner product value P_{fj} (j is an integer of 1 to m), and the sum of the j-th type of weighting coefficient fj is Σfj. By appropriately defining an index for evaluating the closeness to Expression (17) as the reliability, the reliability can be similarly acquired when the number of types of weighting m is any number.

### Sixth Embodiment

In the embodiment, a modification of the configuration of the information processing device 300 according to the first to fifth embodiments will be described. In the embodiment, description of elements common to the first to fifth embodiments may be omitted or simplified.

In the first to third embodiments, the method of generating the inner product value by sequentially multiplying the sub-frame by the weighting coefficient when the sub-frame is generated in the photoelectric conversion device 100 has been described. In addition, in the fourth and fifth embodiments, the configuration in which weighted count values are sequentially generated in the photoelectric conversion device 100 has been described. On the other hand, in the embodiment, a configuration will be described in which a plurality of sub-frames generated in the photoelectric conversion device 100 are acquired in advance, and then weighting calculation is performed.

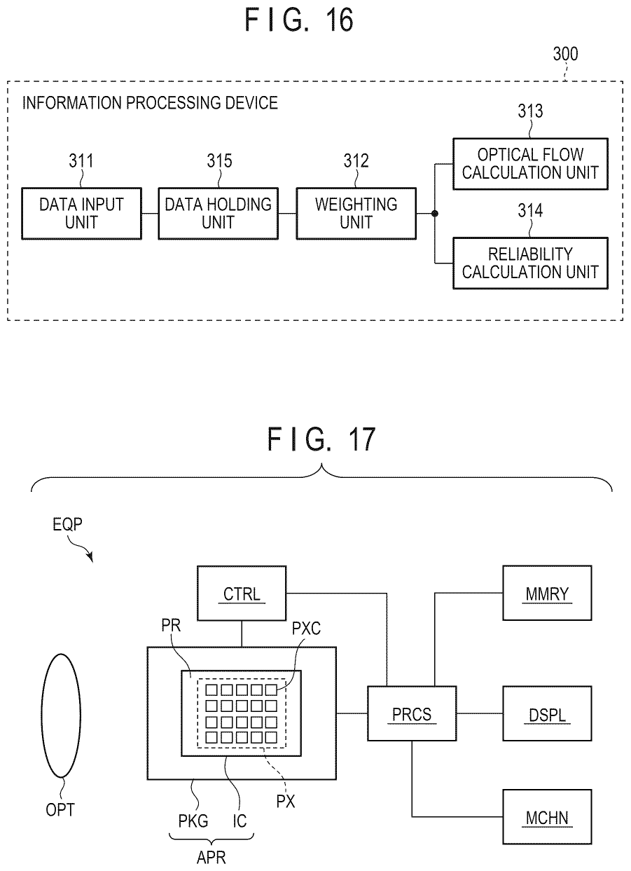

FIG. 16 is a functional block diagram of the information processing device 300 according to the embodiment. The information processing device 300 includes a data holding unit 315 in addition to the configuration of FIG. 2. The function of the data holding unit 315 is realized by a memory in the information processing device 300. The data holding unit 315 may be, for example, the RAM 302 or the storage medium 304 of FIG. 1. The data holding unit 315 has a storage capacity capable of holding at least N sub-frames constituting one main frame.

When a plurality of sub-frames continuously captured by the photoelectric conversion device 100 are generated, the plurality of sub-frames are held in the data holding unit 315 via the data input unit 311. The data holding unit holds the number of sub-frames equal to or greater than the amount of data constituting one main frame. Thereafter, the weighting unit 312 performs processing of calculating an inner product by the method described in the first to third embodiments to generate a normal image and a correlation image. Thereafter, the optical flow calculation unit 313 and the reliability calculation unit 314 respectively calculate the optical flow and the reliability by the methods described in the first to third embodiments.

In the information processing device 300 according to the embodiment, it is not necessary to perform the signal processing of the time correlation imaging in real time at the time of capturing the image, and the signal processing can be performed at any timing after the image is captured. For example, even in a case where the photoelectric conversion device 100 is an imaging device having a high frame rate such as a high-speed camera, a sufficient signal processing time can be secured.

The memory constituting the data holding unit 315 may not be incorporated in the information processing device 300. For example, the data holding unit 315 may be provided in the photoelectric conversion device 100.

### Seventh Embodiment

Equipment according to a seventh embodiment will be described with reference to FIG. 17. FIG. 17 is a block diagram illustrating a schematic configuration of equipment according to the embodiment.

FIG. 17 is a schematic diagram illustrating equipment EQP including a photoelectric conversion device APR. The photoelectric conversion device APR has the function of the photoelectric conversion device 100 according to the first to sixth embodiments. All or part of the photoelectric conversion device APR is a semiconductor device IC. The photoelectric conversion device APR of this example can be used as, for example, an image sensor, an auto focus (AF) sensor, a photometric sensor, a ranging sensor, or the like. The semiconductor device IC has a pixel area PX in which pixel circuits PXC each including photoelectric conversion unit are arranged in a matrix. The semiconductor device IC may have a peripheral area PR around the pixel area PX. Circuits other than the pixel circuits can be arranged in the peripheral area PR.

The photoelectric conversion device APR may have a structure (stacked chips structure) in which a first semiconductor chip provided with a plurality of photoelectric conversion units and a second semiconductor chip provided with a peripheral circuit are stacked. Each of the peripheral circuits in the second semiconductor chip may be a column circuit corresponding to a pixel column of the first semiconductor chip. Each of the peripheral circuits in the second semiconductor chip may be a matrix circuit corresponding to a pixel or a pixel block in the first semiconductor chip. For the connection between the first semiconductor chip and the second semiconductor chip, a through electrode (TSV), an inter-chip wiring by direct bonding of a conductor such as copper, a connection by a micro bump between chips, a connection by wire bonding, or the like can be employed.

The photoelectric conversion device APR may include a package PKG for mounting the semiconductor device IC in addition to the semiconductor device IC. The package PKG may include a base body to which the semiconductor device IC is fixed, a lid such as glass facing the semiconductor device IC, and a connection member such as a bonding wire or a bump for connecting a terminal provided on the base body and a terminal provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR, and is, for example, a lens, a shutter, or a mirror. The control device CTRL controls the photoelectric conversion device APR, and is, for example, a semiconductor device such as an ASIC.

The processing device PRCS processes a signal output from the photoelectric conversion device APR, and constitutes an analog front end (AFE) or a digital front end (DFE). The processing device PRCS is a semiconductor device such as a central processing unit (CPU) or an application specific integrated circuit (ASIC). The display device DSPL is an EL display device, a liquid crystal display device, or the like that displays information (image) obtained by the photoelectric conversion device APR. The storage device MMRY is a magnetic device, a semiconductor device, or the like that stores information (image) obtained by the photoelectric conversion device APR. The storage device MMRY is a volatile memory such as an SRAM or a DRAM, or a nonvolatile memory such as a flash memory or a hard disk drive.

In addition, the processing device PRCS may have the functions of the information processing device 300 according to the first to sixth embodiments. That is, the processing device PRCS may acquire the optical flow using the signals output from the photoelectric conversion devices 100 according to the first to sixth embodiments. For example, the processing device PRCS may generate a weighted correlation image based on a sine function, a weighted correlation image based on a cosine function, and a normal image, and acquire an optical flow from these three images.

The mechanical device MCHN includes a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, in one embodiment, the equipment EQP further include a storage device MMRY and a processing device PRCS separately from the storage circuit unit and the arithmetic circuit unit included in the photoelectric conversion device APR. The mechanical device MCHN may be controlled based on a signal output from the photoelectric conversion device APR.

The equipment EQP illustrated in FIG. 17 may be an electronic device such as an information terminal (for example, a smartphone and a wearable terminal) having a photographing function, a camera (For example, an interchangeable lens camera, a compact camera, a video camera, and a surveillance camera), or the like. The mechanical device MCHN in the camera may drive parts of the optical device OPT for zooming, focusing, and shutter operation. Also, the equipment EQP may be a transport device (movable body) such as a vehicle, a ship, a drone, or an airplane. The equipment EQP may be a medical device such as an endoscope or a CT scanner. The equipment EQP may be a measurement device such as a ranging sensor, an analysis device such as an electron microscope, an office device such as a copier, or an industrial device such as a robot.

The mechanical device MCHN in the transport device may be used as a movable device. The equipment EQP as a transport device is suitable for transporting the photoelectric conversion device APR, or for assisting and/or automating driving (manipulation) by an imaging function. The processing device PRCS for assisting and/or automating driving (manipulation) may perform processing for operating the mechanical device MCHN as a movable device based on information obtained by the photoelectric conversion device APR.

According to the first to sixth embodiments, signal acquisition can be performed satisfactorily. Therefore, the photoelectric conversion device APR or the processing device PRCS according to the first to sixth embodiments may provide a high value to a designer, a manufacturer, a seller, a purchaser, and/or a user thereof. Therefore, when the photoelectric conversion device APR or the processing device PRCS is mounted on the equipment EQP, the value of the equipment EQP may also be increased. Therefore, in manufacturing and selling the equipment EQP, it is advantageous to determine the mounting of the photoelectric conversion device APR or the processing device PRCS of the embodiment on the equipment EQP in order to increase the value of the equipment EQP. Here, increasing the value corresponds to at least one of adding a function, improving performance, improving characteristics, improving reliability, improving manufacturing yield, reducing environmental load, reducing cost, reducing size, and reducing weight.

For example, by mounting the photoelectric conversion device APR in a transport device, it is possible to obtain excellent performance when photographing outside the transport device or measuring an external environment. Therefore, in manufacturing and selling the transport device, it is advantageous to determine the mounting of the photoelectric conversion device APR according to the embodiment on the transport device in order to improve the performance of the transport device itself. In particular, the photoelectric conversion device APR is suitable for a transport device that performs driving support and/or automatic driving of the transport device using information obtained by the photoelectric conversion device APR.

### Eighth Embodiment

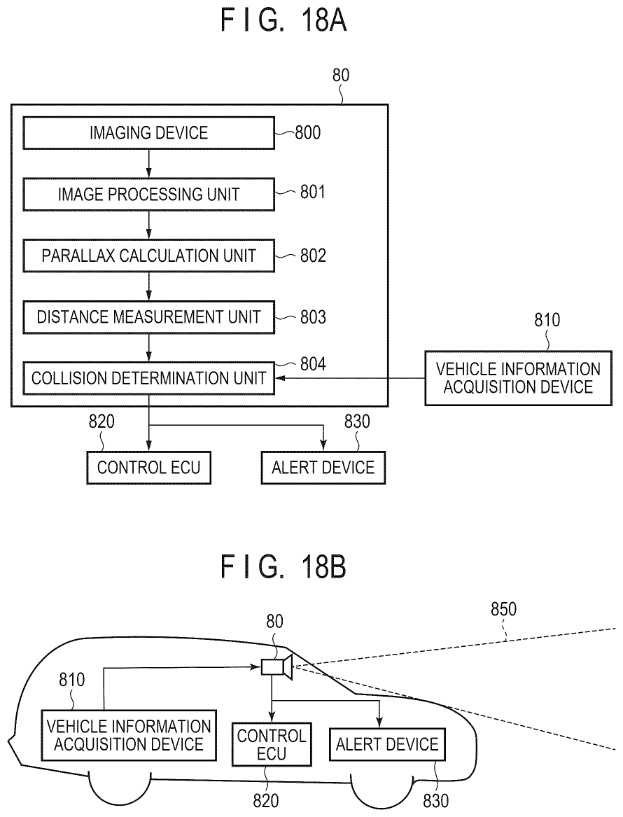

FIGS. 18A and 18B are block diagrams of equipment relating to the vehicle-mounted camera according to the embodiment. FIGS. 18A and 18B illustrate an example in which the above-described photoelectric conversion device is applied to a movable body such as a vehicle. The equipment 80 includes an imaging device 800 (an example of the photoelectric conversion device) and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80.

Here, the equipment 80 may include an optical system (not illustrated) that guides light to the imaging device 800. The optical system may include, for example, a lens, a shutter, and a mirror. A plurality of photoelectric conversion units substantially conjugate to the pupil of the optical system may be arranged in a pixel included in the imaging device 800. For example, a plurality of photoelectric conversion units are arranged corresponding to one microlens. The plurality of photoelectric conversion units may receive light fluxes transmitted through different positions of the pupil of the optical system. Thus, the imaging device 800 outputs a plurality of pieces of image data respectively corresponding to the light fluxes transmitted through different positions of the pupil of the optical system. Then, the parallax calculation unit 802 may calculate the parallax using the plurality of pieces of image data being output.

The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. Note that the distance information may be acquired using a time of flight (ToF) technique. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the embodiment, an image of the periphery of the vehicle, for example, the front or the rear is captured by the equipment 80. FIG. 18B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### OTHER EMBODIMENTS

The disclosure is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the disclosure.

The embodiments described above can be appropriately modified without departing from the technical idea. Note that the disclosure of the specification includes not only the matters described in the specification but also all matters that can be grasped from the specification and the drawings attached to the specification. Also, the disclosure of the specification includes a complementary set of the concepts described in the specification. In other words, for example, when there is a description of “A is greater than B” in the specification, it can be said that the description of “A is not greater than B” is disclosed in the specification even when the description of “A is not greater than B” is omitted. This is because it is assumed that the case where “A is not greater than B” is considered when “A is greater than B” is described.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the disclosure, and the technical scope of the disclosure should not be interpreted in a limited manner by these embodiments. That is, the disclosure can be implemented in various forms without departing from the technical idea or the main features thereof.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-010856, filed Jan. 24, 2025, which is hereby incorporated by reference herein in its entirety.

What is claimed is:

1. A system comprising:
a weighting unit configured to acquire a first inner product of time-series pixel data including a plurality of pixel values in time series as elements and a first coefficient sequence including a plurality of weighting coefficients respectively corresponding to the plurality of pixel values as elements, and configured to acquire a second inner product of the time-series pixel data and a second coefficient sequence including a plurality of weighting coefficients respectively corresponding to the plurality of pixel values as elements; and
a calculation unit configured to calculate a reliability regarding calculation accuracy of an optical flow from the plurality of pixel values based on the first inner product and the second inner product.

2. The system according to claim 1, wherein a weighting coefficient of the first coefficient sequence periodically changes with respect to an acquisition time of corresponding pixel value.

3. The system according to claim 1, wherein a weighting coefficient of the second coefficient sequence is constant with respect to an acquisition time of corresponding pixel value.

4. The system according to claim 1,
wherein a weighting coefficient of the first coefficient sequence periodically changes with respect to an acquisition time of corresponding pixel value,
wherein a weighting coefficient of the second coefficient sequence is constant with respect to an acquisition time of corresponding pixel value, and
wherein the calculation unit calculates the reliability such that the reliability decreases as a ratio of the first inner product to the second inner product is closer to a predetermined value.

5. The system according to claim 1,
wherein the weighting unit acquires a third inner product of the time-series pixel data and a third coefficient sequence including a plurality of weighting coefficients respectively corresponding to the plurality of pixel values as elements, and
wherein the calculation unit calculates the reliability further based on the third inner product.

6. The system according to claim 5, wherein a weighting coefficient of the third coefficient sequence periodically changes with respect to an acquisition time of corresponding pixel value.

7. The system according to claim 5,
wherein a weighting coefficient of the first coefficient sequence periodically changes with respect to an acquisition time of corresponding pixel value,
wherein a weighting coefficient of the second coefficient sequence is constant with respect to an acquisition time of corresponding pixel value,
wherein a weighting coefficient of the third coefficient sequence periodically changes with respect to an acquisition time of a corresponding pixel value at a phase different from that of the weighting coefficient of the first coefficient sequence, and
wherein the calculation unit calculates the reliability based on a value obtained by an expression including a term including the first inner product, the second inner product, and the third inner product.

8. The system according to claim 7, wherein the calculation unit calculates the reliability based on the value obtained by the expression including a term for subtracting the second inner product from a sum of the first inner product and the third inner product.

9. The system according to claim 5,
wherein a weighting coefficient of the first coefficient sequence periodically changes with respect to an acquisition time of corresponding pixel value,
wherein a weighting coefficient of the second coefficient sequence is constant with respect to an acquisition time of corresponding pixel value,
wherein a weighting coefficient of the third coefficient sequence periodically changes with respect to an acquisition time of a corresponding pixel value at a phase different from that of the weighting coefficient of the first coefficient sequence, and
the calculation unit calculates the reliability based on a value obtained by an expression including a product of a term including the first inner product and the second inner product, and a term including the third inner product and the second inner product.

10. The system according to claim 1, wherein the calculation unit determines whether the reliability is less than a threshold value and outputs a determination result.

11. The system according to claim 10, wherein the calculation unit dynamically determines the threshold value based on information included in the time-series pixel data or information of an imaging environment in which the time-series pixel data is generated.

12. The system according to claim 1, wherein the calculation unit calculates the reliability based on a value obtained by an expression normalized by dividing a term including the first inner product and the second inner product by a term including the second inner product.

13. The system according to claim 1, wherein the calculation unit calculates the reliability such that the smaller the temporal change of the time-series pixel data is, the smaller the value of the reliability is.

14. The system according to claim 1 further comprising a photoelectric conversion unit configured to generate a signal according to incident light,
wherein the weighting unit acquires the first inner product by performing weighted accumulation based on a plurality of the signals input in time series and a reference signal indicating the plurality of weighting coefficients.

15. The system according to claim 14,
wherein the photoelectric conversion unit includes an avalanche photodiode, and
wherein the weighting unit acquires the first inner product by counting a number of pulses of the reference signal when a photon enters the avalanche photodiode.

16. The system according to claim 14 comprising a plurality of photoelectric conversion units,
wherein the plurality of photoelectric conversion units include a first photoelectric conversion unit configured to generate a signal used to generate the first inner product and configured not to generate a signal used to generate the second inner product, and a second photoelectric conversion unit configured to generate a signal used to generate the second inner product and configured not to generate a signal used to generate the first inner product.

17. The system according to claim 16,
wherein the plurality of photoelectric conversion units form an array in which the first photoelectric conversion unit and the second photoelectric conversion unit are repeatedly arranged, and
wherein in the array, a number of the second photoelectric conversion units is greater than a number of the first photoelectric conversion units.

18. The system according to claim 1 further comprising a memory configured to store the time-series pixel data,
wherein the weighting unit performs processing of reading the time-series pixel data from the memory and acquiring the first inner product and the second inner product after the time-series pixel data of an amount equal to or greater than a data amount constituting one image is stored in the memory.

19. The system according to claim 1 further comprising an optical flow calculation unit configured to calculate the optical flow based on the first inner product and the second inner product,
wherein when the reliability is equal to or greater than a threshold value, the optical flow calculation unit calculates the optical flow, and
wherein when the reliability is less than the threshold value, the optical flow calculation unit does not calculate the optical flow.

20. Equipment comprising:
the system according to claim 1; and
at least any one of:
an optical device adapted for the system,
a control device configured to control the system,
a processing device configured to process a signal output from the system,
a display device configured to display information obtained by the system,
a storage device configured to store information obtained by the system, and
a mechanical device configured to operate based on information obtained by the system.
